(19) United States
(12) Patent Application Publication
(10) Pub. No.: US 2004/0051926 A1
(43) Pub. Date: Mar. 18, 2004

(54) Photoelectronic mixing device (pmd) system

(76) Inventors: Peter Gulden, Munchen (DE); Patric Heide, Vaterstetten (DE); Martin Vossiek, Hildesheim (DE)

Correspondence Address: YOUNG & THOMPSON, 745 SOUTH 23RD STREET 2ND FLOOR, ARLINGTON, VA, 22202

(21) Appl. No.: 10/381,252

(22) PCT Filed: Sep. 20, 2001
(86) PCT No.: PCT/DE01/03647

(30) Foreign Application Priority Data
Sep. 22, 2000 (DE) 10047170.6

(51) Int. Cl. G02F 1/00

(52) U.S. Cl. 359/237

(57) ABSTRACT

The PMD system comprises at least one PMD element (PMD), at least one transmitter (E), whose intensity can be modulated, and at least one controlling electronic device (FG) by means of which the PMD element (PMD) and the transmitter (E) can be controlled with at least one respective modulation voltage (U_{mod}, U_{mod}, U_{Txmod}), and by means of which a phase shift (Δf) can be altered by an actuating signal. The PMD system is characterized in that a controlled system (CTR) is provided into which at least one output signal (Uₐ, U_{b}, U_{d}) of the PMD element (PMD) can be fed as a controlled variable (U′_{d}) and whose output signal (U₁ₚₕₛ, U_{1fc}) can be fed into the controlling electronic device (FG) as an actuating signal, whereby the controlled variable (U′_{d}) can be set to the value of a predetermined target variable by the controlled system (CTR).

The invention relates to a PMD (Photoelectronic Mixing Device) system as well as to a method for controlling a PMD system.

In principle, a PMD corresponds to a pixel of a CMOS camera chip. In the PMD, both the intensity and the propagation time of an intensity-modulated lightwave sent by a transmitter and received by the PMD can be measured. In the PMD, as on a conventional photodiode, the light generates charge carriers whose number is proportional to the intensity of the light.

The special feature of the PMD arrangement is that two opposite outputs A and B are opened alternately. Switching between the two outputs is accomplished via a modulation voltage U_{mod}, which is applied to the PMD. This modulation voltage U_{mod} is modulated at the same frequency f_{mod} as the amplitude of the lightwave transmitted by the transmitter. If the light now reaches the PMD without delay, the time in which charge carriers are generated corresponds to the open time of output A. The generated charges therefore reach output A in their entirety. If the arrival of the lightwave at the PMD is delayed, the charge carriers are generated correspondingly later. Thus, some of the charges are generated during the time that output A is open, whereas others are generated during the time that output B is open. Therefore, the difference between output A and output B is a measure for the propagation time of the signal, whereas the sum of A and B is a measure for the intensity of the incident light (see: DE 197 04 496 A1, or R. Schwarte et al., “Schnelle und einfache optische Formerfassung mit einem neuartigen Korrelations-Photodetektor-Array” (“Quick and easy optical form capture using a novel correlation photodetector array”), paper presented at the DGZfP-GMA Conference in Langen, 28/29 Apr. 1997.

The readout voltages Uₐ from output A and U_{b} from output B are generated directly by the generated charge current in the so-called non-integrating operating mode. In the so-called integrating operating mode, the readout voltages Uₐ and U_{b} are those voltages that are produced at the charge pots following integration of the charges. A special feature of integrating PMDs is that the pots in which the charge carriers are collected have to be emptied regularly by means of a reset signal R. The reset can either be effected after fixed, predefined time intervals tᵢ using the frequency fᵢ=1/tᵢ or adaptively when a certain voltage threshold is reached at the charge pots.

With sinusoidal modulation, the following applies to the output signals Uₐ and U_{b} of the PMD, which correspond to the product of the incident electromagnetic waves with the modulation signal U_{PMDmod} and the 180° phase-shifted modulation signal \overline{U}_{PMDmod}, depending on the implementation of the accumulation gate (integrating/non-integrating), assuming the same frequency of the incident intensity-modulated lightwaves and the modulation signal, and with subsequent suppression of high-frequency components:

a) with integrating implementation:

Uₐ=K·tᵢ·P_{M}·cos(Δφ)+K·tᵢ·P_{H}/2 (1.1)

Uₐ=K·tᵢ·P_{M}·cos(Δφ+180°)+K·tᵢP_{H}/2 (1.2)

b) with non-integrating implementation:

Uₐ=K·P_{M}·cos(Δφ)+K·P_{H}/2 (2.1)

U_{b}=K·P_{M}·cos(Δφ+180°)+K P_{H}/2 (2.2)

Here, Δφ corresponds to the phase shift between the incident lightwave and the modulation signal, P_{M} to the power of the incident wave, tᵢ to the integration time, K to a proportionality factor taking account of the sensitivity of the PMD and the amplitude of the modulation voltage, and P_{H} to the power of the background lighting. By forming the difference signal, the background lighting is suppressed and the following applies to the difference signal U_{d}=Uₐ−U_{b}:

U_{d}=2·K·tᵢ·P_{M}·cos(Δφ) (3),

and

U_{d}=2·K·P_{M}·cos(Δφ) (4).

A problem for directly calculating the phase shift is the dependence of the output signals both on cos(Δφ) and on P_{M}.

The phase shift Δφ is composed of the phase difference due to the propagation time φ_{tof} and the phase difference due to the (selectable) phase delay φd. Thus, with the propagation time τ_{tof}, the modulation frequency f_{mod} and an additional phase delay φ_{d}, the following applies:

Δφ=φ_{tof}+φ_{d}=2π·f_{mod}·τ_{tof}+φ_{d} (5)

Ideally, φ_{d} is zero, or an exactly selectable value. If equation (5) is converted to determine the distance after the propagation time τ_{tof}, then the following applies:

$$d = \frac{c}{2} \cdot \frac{Δ ϕ \cdot - \cdot ϕ d}{2 \cdot π \cdot f mod} \qquad ( 6 )$$

It is the object of the present invention to provide a means of improved determination of the propagation time τ_{tof} and/or the propagation time-related phase difference of a PMD system.

This object is achieved by a PMD system according to Claim 1 as well as a method for controlling a PMD system according to Claims 18 and 19.

To this end, a PMD system comprises at least one PMD element and at least one transmitter for intensity-modulated transmission of electromagnetic waves. The PMD element can be implemented as an integrating or non-integrating device. The transmitter is typically a light source, but can also transmit other suitable electromagnetic radiation, e.g. general radio waves such as microwaves or radar waves.

Also provided is at least one controlling electronics device by means of which the PMD element and the transmitter can each be controlled using at least one modulation voltage of the same modulation frequency. In this case the signal levels of the modulation voltages for PMD element and transmitter can vary from one another, for example to adjust to a device-specific parameter such as a maximum input level. The controlling electronics device can either be fed from outside with a clock signal or include a frequency generator.

The controlling electronics device can modify a phase shift Δφ. This takes place according to equation (5) by means of a change to the modulation frequency f_{mod} and/or by setting the phase delay φ_{d}. The modification of the phase shift Δφ is controlled via an actuating signal routed to the controlling electronics device.

Additionally provided is a controlled system into which at least one output signal Uₐ, U_{b} or a combination of the output signals, e.g. the difference signal U_{d} of the PMD element, can be injected as a control variable U′_{d}. The controlled system can be implemented either as an analog or as a digital system. The minimum of one output signal Uₐ, U_{b}, U_{d} can be used directly as a control variable U′_{d} or following a signal processing operation, for example a subtraction of two output signals Uₐ, U_{b} and/or a following signal preprocessing operation.

The controlled system is connected to the controlling electronics device such that an output signal is used as an actuating signal for the controlling electronics device. As a result, the phase shift Δφ can be controlled by the controlled system such that the control variable U′_{d} can be set to the value of a predefined target variable. Consequently, the PMD system can control itself automatically as a closed-loop system. By means of the controlled system, therefore, a control variable U′_{d} characterizing the PMD system or the closed-loop system is adjusted to the target variable.

The phase delay φd can be set directly, e.g. via a phase shifter. Alternatively, or in addition, the modulation frequency f_{mod} can be varied. With both types, the variation is preferably performed in such a way that the total phase difference Δφ from equation (5) corresponds to a characteristic value, e.g. 90°, 180°, 270° or 360°. In each case this corresponds to a control variable U′d=0, min, or max. With a setting of U′_{d}=minimum or maximum, voltage signals proportional to the power of the received modulated light P_{M} and to the background light P_{H} can be generated. All the signals are available advantageously independently of one another; the desired phase and intensity information can be recorded with a single measurement. Settings to other characteristic values are also possible, however.

When the frequency is used to control the PMD system, it is advantageous if the lowest frequency is chosen as the starting point at the beginning of a control operation, and then an adjustment is made in the direction of the next-higher frequency, which sets the desired value of the control variable U′_{d}.

Due to the interruptions caused by the reset of the integrating PMD, it is advantageous if a device for signal preprocessing is inserted in the circuit ahead of the controlled system.

Owing to the special waveform of the output signals of integrating PMDs, it is particularly favorable if the signal preprocessing device includes at least a first low-pass filter, followed by a device for time differentiation, followed by a switch controllable by means of a reset signal, and followed by a second low-pass filter. The reset signal can be normal or processed, e.g. inverted.

It can also be advantageous for suppressing interference caused by the controllable switches if the signal preprocessing device includes at least one low-pass filter, followed by a switch controllable by means of a reset signal, and followed by a sample-and-hold gate.

To achieve a simple technical implementation, it can also be favorable if the signal preprocessing device includes at least one first low-pass filter, followed by a device for time differentiation, and followed by a second low-pass filter.

It is also advantageous for sensitive and at the same time stable differentiation of the signal in a signal preprocessing operation if a limit frequency of the first low-pass filter is in the range of 5.5 times the integration frequency fₜᵢ, particularly if a limit frequency of the second low-pass filter lies within the range of three times the integration time fₜᵢ.

It is favorable if the minimum of one modulation voltage driving the PMD element and the minimum of one modulation voltage driving the transmitter can be provided with a phase delay φ_{d} with respect to each other. This can be effected, for example, by means of a phase delay φ_{d} of one of the two modulation voltages or by different phase delays of the two modulation voltages.

For improved determination of a setting of the phase delay φ_{d}, there is advantageously provided at least one phase comparator which compares the phase of at least one modulation voltage applied to the PMD element and at least one modulation voltage applied to the transmitter. This is effected, for example, in that a modulation voltage driving the PMD element is applied at one input of the phase comparator, and a modulation voltage driving the transmitter is applied at a further input. A phase difference is determined by comparing the minimum of two modulation voltages.

It is advantageous if the controlling electronics device includes at least one driver that is controllable by means of a clock signal, said driver supplying the PMD element with the minimum of one modulation voltage (U_{mod}, \overline{U}_{mod}). The clock signal can be provided either by an external signal source or by a clock generator provided in the controlling electronics device, e.g. a frequency generator. Also present is a phase delay element which is controllable by the controlled system and by means of which the clock signal can be forwarded to the transmitter with a phase delay φ_{d}. However, it is also possible to introduce the phase delay element, favorably a phase shifter, ahead of the PMD element.

It is particularly preferred to implement the phase delay element in the form of a phase shifter which includes a comparator with a subsequent series-connected D flip-flop as a clock splitter. This is particularly advantageous if the PMD system is present as an integrated circuit, e.g. if such a phase shifter and a controlled system are integrated into the PMD element. This makes a signal, typically a voltage value, that is directly dependent on the propagation time τ_{tof} or the distance from the object available in each PMD device PMD. This is particularly favorable when used in an array consisting of multiple PMD devices or PMD elements. An array consisting of a plurality of the above-mentioned PMD systems is also preferred for other designs, however.

In order to control the PMD system via the modulation frequency f_{mod}, it is also favorable if the PMD system includes at least one controlling electronics device containing a driver that is controllable by means of a clock signal and supplies the PMD element with the minimum of one modulation voltage, as well as a controllable frequency source which generates the clock signal for the driver and the modulation voltage for the transmitter. In particular, a voltage-controlled oscillator is preferred. The controllable frequency source can be, for example, a voltage-controlled oscillator (VCO), a direct digital synthesis (DDS) device or a phase-locked loop (PLL) device.

To simplify the measurement of the adjusted frequency of the PMD system via the frequency, it is advantageous if the adjusted clock signal of the controllable frequency source is fed into an f-to-U converter, particularly an incrementally counting f-to-U converter.

The measured values of the PMD system can be directly processed further by analog or digital means, e.g. for a suitable averaging process.

The method for determining the phase difference is represented schematically in greater detail in the following exemplary embodiments.

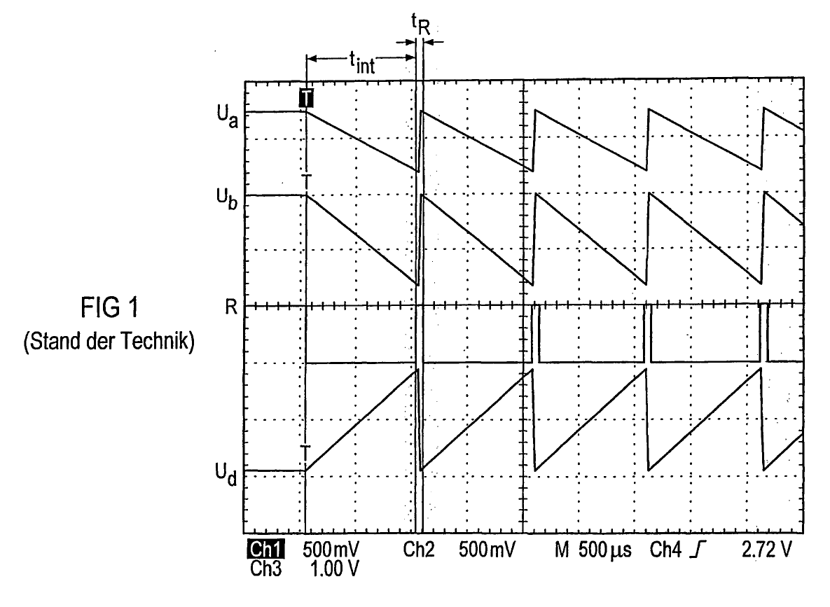

FIG. 1 shows a typical output and reset signal of a PMD element according to the prior art,

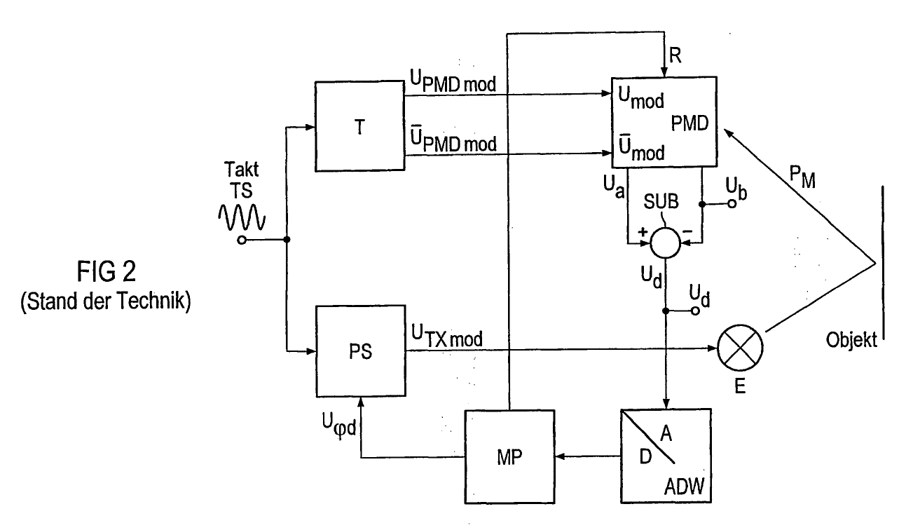

FIG. 2 shows a PMD system according to the prior art with adjustable phase delay φ_{d},

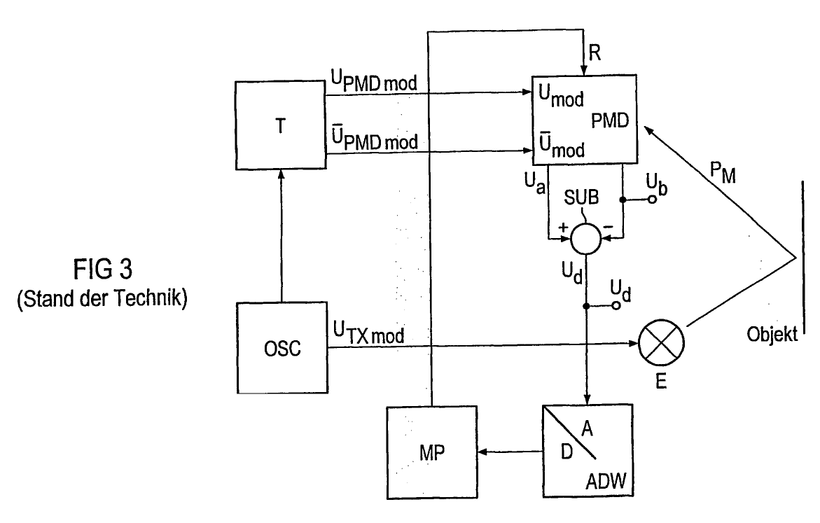

FIG. 3 shows a PMD system according to the prior art with adjustable modulation frequency f_{mod},

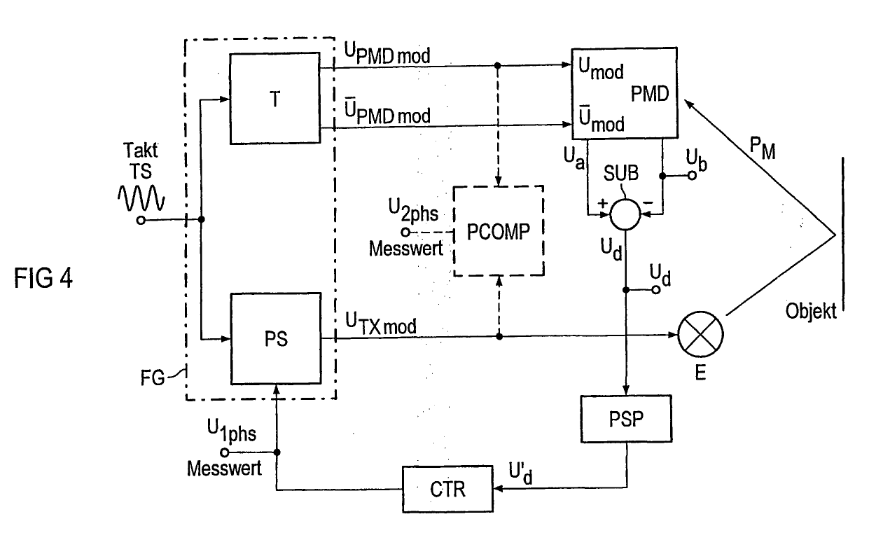

FIG. 4 shows a PMD system with adjustable phase delay φ_{d} and controlled system,

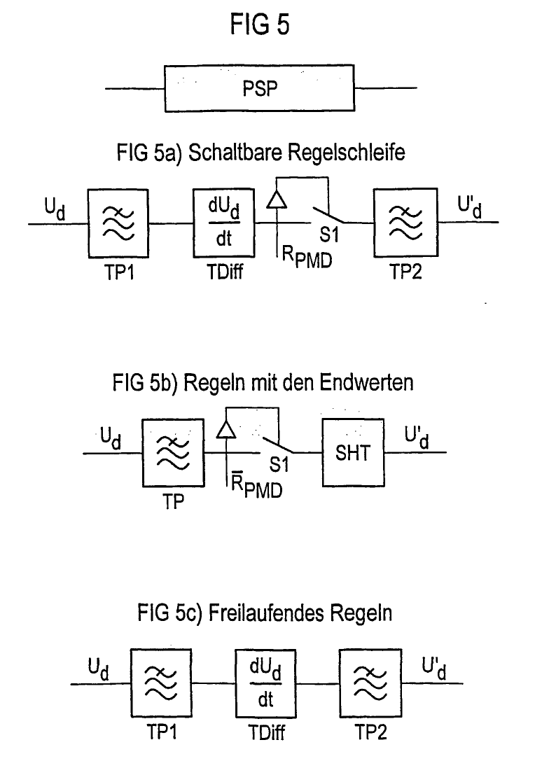

FIG. 5 shows multiple embodiments of a signal preprocessing device,

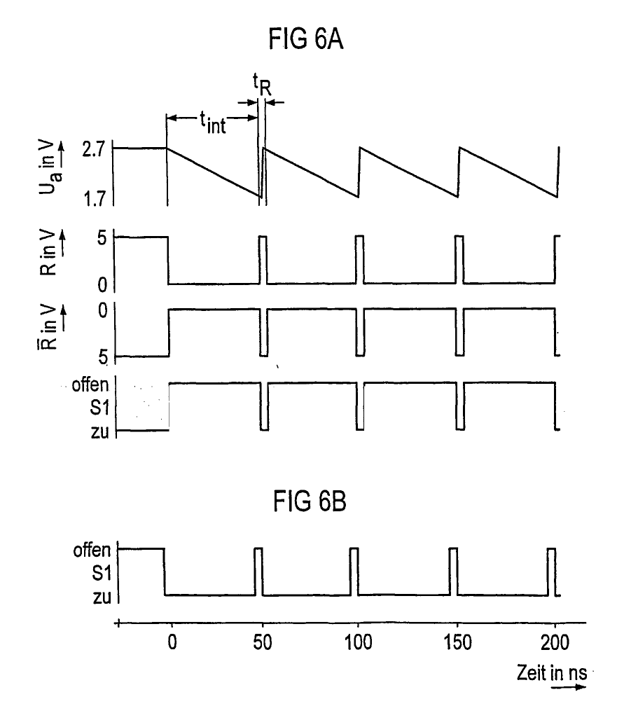

FIG. 6 shows various signals associated with the signal preprocessing device,

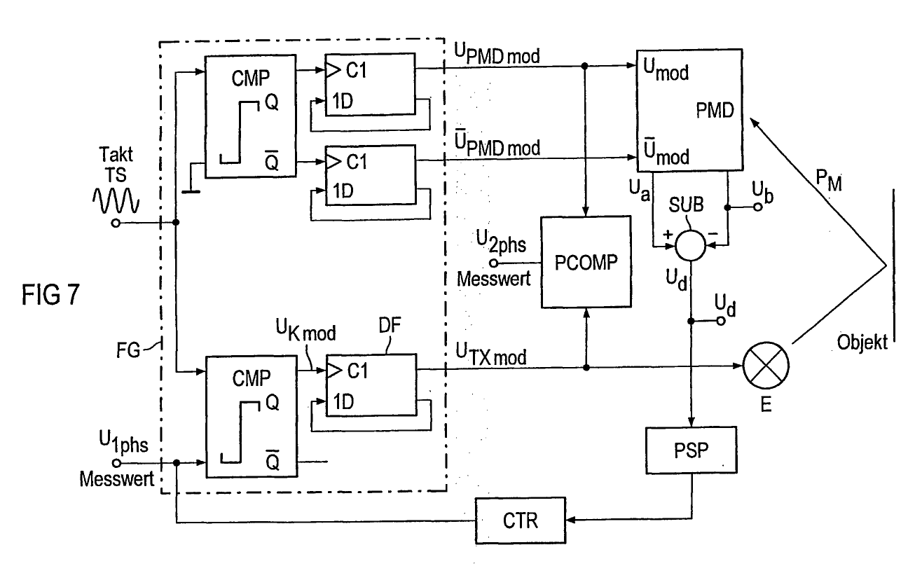

FIG. 7 shows a further PMD system with adjustable phase delay φ_{d} and analog controlled system,

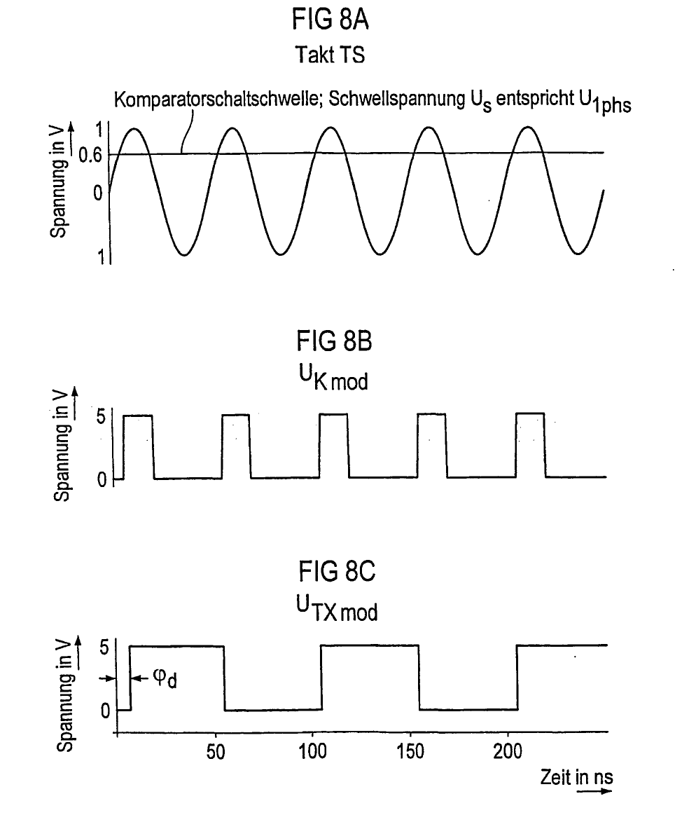

FIG. 8 shows various signal waveforms associated with the PMD system from FIG. 7,

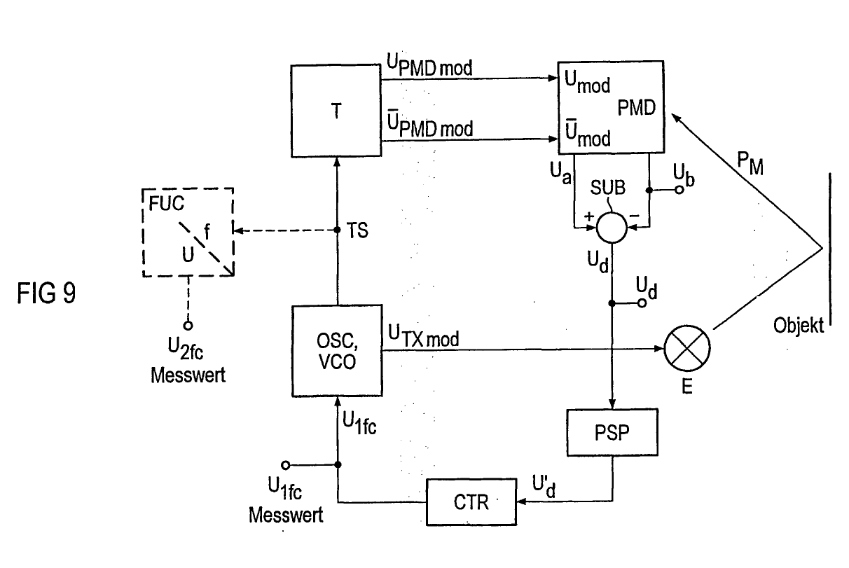

FIG. 9 shows a PMD system with adjustable modulation frequency f_{mod} and controlled system.

FIG. 1 shows a plot of the output signals Uₐ and U_{b} of a PMD element PMD, the difference signal U_{d} and the reset signal R of a microprocessor MP in V plotted against the time t in μs for an integrating PMD element PMD according to Schwarte et al.: “A new electrooptical mixing and correlating sensor: Facilities and Applications of the Photonic Mixer Device (PMD)”, presentation at Laser 97, Munich.

The output signals Uₐ and U_{b} are linear in sections within a time interval tᵢₙₜ and are reset by a reset signal R of duration t_{R}.

FIG. 2 shows a circuit schematic of a PMD system for determining the phase shift by means of a PSK method according to Heinol et al.: “Laufzeitbasierte 3D-Kamerasysteme—Smart Pixel Lösungen” (“Propagation time-based 3D camera system—smart pixel solutions”), DGZIP Conference on Optical Form Capture, Stuttgart, 5-6 Sep. 1999.

In this case an adjustable phase shifter PS and a driver T are clocked by means of a clock signal TS, which typically is generated by a clock generator. The driver T forwards the modulation signal U_{PMDmod} and the 180° phase-shifted modulation signal \overline{U}_{PMDmod} to the PMD element PMD. The output signals Uₐ and U_{b} are generated by the PMD element PMD as a function, among other things, of a power P_{M} of the incident wave. The associated difference signal U_{d} can be determined either digitally or by means of a, preferably analog, subtractor SUB. This subtractor SUB can be integrated into the PMD pixel.

The difference signal U_{d} is input via an A/D converter ADW into a microprocessor MP which, dependent among other things on the value of the difference signal U_{d}, passes on both the reset signal R to the PMD element PMD and the phase signal U_{d} to the phase shifter PS. The phase shifter PS is therefore set to a specific phase delay φ_{d} by the microprocessor MP.

The transmitter E is controlled by the phase shifter PS via the modulation signal U_{TXmod} intended for it. For the purpose of adjustment to the controlled devices, U_{PMDmod} and U_{TXmod} differ only in respect of their signal level.

The intensity-modulated lightwave transmitted by the transmitter E runs via the transmission section and reaches the PMD element PMD with the phase difference Δφ=φ_{d}+φ_{tof}, where φ_{tof} is the phase/propagation time difference caused by traveling the transmitter-PMD transmission section. The PMD element PMD then generates the output signals Uₐ, U_{b} according to the equations (1.1)-(1.2), or (2.1)-(2.2). The difference signal U_{d} is then formed according to equation (3) or (4) and digitized by means of the A/D converter ADW. The microprocessor MP stores the result and sets a new phase delay vale φ_{d}. In this way the values of the output signal U_{d} are recorded for different discrete values of the phase delays φ_{d} in the range 0° to 360°. The resulting correlation curve reveals a maximum at Δφ=360°. φ_{tof} can then be determined via the exact determination of the maximum by means of interpolation from the discrete measured values, yielding φ_{tof}=360°=φ_{d}(U_{d;max}).

The resulting technical overhead involved in this method is considerable: multiple measured values must be recorded and stored, and then the minimum and maximum found. Additional computing overhead results due to the use of interpolation techniques for determining the maximum with the greatest possible precision. In Heinol et al., for example, the phase delay is generated by means of direct digital frequency synthesis (“DDS”) and a digital phase register.

FIG. 3 shows a circuit schematic of a PMD system with adjustable modulation frequency f_{mod} without controlled system CTR.

A detunable oscillator OSC sends a modulation signal U_{mod} with a first modulation frequency f_{mod}. Its output signal U_{TXmod} is sent as an intensity-modulated signal by the transmitter E and simultaneously reaches the PMD as U_{PMDmod} via the driver T. There, it is overlaid analogously to FIG. 2. The difference signal U_{d} is scanned directly by the A/D converter and stored in the microprocessor MP. There, a spectral analysis is performed in order to determine the Doppler frequency and the phase is calculated. The microprocessor MP then sets a new value for the modulation frequency f_{mod}, and the next value for U_{d} is recorded. With an integrating PMD, usefully followed by a series-connected differentiator, a reset signal R is sent to the PMD by the microprocessor MP.

The distance can be calculated either by direct solving of the equations for the propagation time tₜ of and the factor K (with the FSK method), via a search for the maximum in the correlation curve (with the FSK method), or by means of Fourier analysis (FMCW method). Disadvantages here are once again the requirement to record multiple measured values and the need for mathematical evaluation of the measured data.

In order to determine the phase difference or propagation time difference, it is possible to record multiple measured values, for example using PSK (Phase Shift Key), FSK (Frequency Shift Key), FMCW (Frequency Modulated Continuous Wave) or PN modulation.

FIG. 4 shows a circuit diagram of a PMD system with variable phase delay φ_{d} and controlled system CTR.

The PMD system features a modulation-capable transmitter E, a PMD element PMD, a PMD driver T, a tunable phase delay element in the form of a phase shifter PS, a subtractor SUB, a controlled system CTR and a signal preprocessing device PSP. For increased precision, a phase comparator PCOMP can additionally be inserted.

The clock input signal TS is applied to the PMD driver T and the phase shifter PS. The PMD driver T generates the modulation voltage U_{PMDmod} and the 180°-shifted complementary signal \overline{U}_{PMDmod} from the clock signal TS. These two voltages are applied to the PMD element PMD. The phase shifter PS delays the clock signal TS by the phase delay φ_{d} before the signal is passed to the transmitter E. The phase delay φ_{d} is dependent here on the control variable U₁ₚₕₛ applied to the phase shifter PS. The phase-delayed signal U_{TXmod} is sent by the transmitter E and reaches the PMD element PMD via the transmission section with the phase delay Δφ=φ_{d}+φ_{tof}.

The output signals Uₐ and U_{b} described in the equations (1.1), (1.2), and (2.1), (2.2) are generated at the output gates of the PMD element PMD. These signals are proportional to Δφ. The difference signal U_{d} is formed from the output signals Uₐ, U_{b} according to equations (3) and (4). Following possible signal preprocessing in the signal preprocessing device PSP, the difference signal U_{d} is applied as control variable U′_{d} to the controlled system CTR. Without signal preprocessing there is an equivalence where U_{d}=U′_{d}.

Via a signal output by the controlled system CTR, in this case a voltage U₁ₚₕₛ, the phase shifter PS is adjusted such that the control variable U′_{d} corresponds as precisely as possible to a predefined target variable. The voltage U₁ₚₕₛ is then a measure for the phase delay φ_{d} between sent and received light.

For increased precision, an additional phase comparator PCOMP can be used for determining the set phase delay φ_{d}. The output voltage U₂ₚₕₛ of this phase comparator then also represents a measure for the phase delay φ_{d}. In this exemplary embodiment, the phase comparator PCOMP is connected to an output of the driver T and to an output of the phase shifter PS and compares U_{PMDmod} with U_{TXmod}.

Possible target variables that are particularly suitable for the closed-loop control system are:

a) U′_{d}=0;

b) U′ₐ=maximum;

c) U′_{d}=minimum.

Case a): For U′_{d}=0, the phase delay is set automatically to Δφ=90°, see equations (3) and (4). In this case the phase delay caused by the propagation time tₜ of corresponds to φ_{tof}=90−φ_{d}. The phase delay φ_{d}, and hence φ_{tof}, can be determined directly from the characteristic curve of the phase shifter PS or the adjusted voltage U₁ₚₕₛ.

To increase the measuring accuracy, φ_{d} can also be determined directly from the output signal U₂ₚₕₛ of the phase comparator PCOMP. With the target variable U′_{d}=0, φ_{d} is determined in both cases independently of the power P_{M} of the modulated light. A disadvantage here, however, is that the ambiguity range is limited to 180°.

Case b): With U′_{d}=maximum, a phase angle Δφ=180° is set. φ_{tof} can be determined via φ_{tof}=180°−φd; the corresponding voltage values proportional to the phase delay φ_{d} are determined analogously to case a). An additional advantage compared with case a) consists in the full separation of parasitic light and modulated light. For Δφ=180°, the voltage component based on the modulated light becomes zero in Uₐ according to equation (1,1) or (2.7.), and conversely maximum in U_{b} according to equation (1.2) or (2.2). Thus, the amount of U_{d} in equation (3) or (4) is now only proportional to the power P_{M} of the incident modulated light quantity. Furthermore, only a voltage signal proportional to the background light quantity is generated at the corresponding opposite gate. Thus, Uₐ is proportional to the power P_{M} of the background light. In contrast to case a), the ambiguity range is 360°.

With this arrangement, voltage-proportional signals relating to phase difference, power of the modulated light and power of the background light are obtained in a single measuring operation for the first time. The corresponding measured values can be further processed directly by analog or digital means, e.g. for a suitable averaging process.

Case c): U′_{d}=minimum yields the same result as case b), with the sole exception that the output voltages Uₐ, U_{b} and hence the sign of U_{d} are swapped.

A setting to other target values is also possible, e.g. areas of maximum gradient.

The type of signal preprocessing depends on the type of output signals of the PMD element PMD. With integrating PMD elements PMD according to [Schwarte, Patent DE197044996 A1], a differentiator TDiff is typically connected in series at the output. With likewise possible PMD elements PMD without integrating output, signal preprocessing can often be dispensed with, in which case U_{d}=U′_{d}.

The controlled system CTR can be dimensioned, for example, as described in [H. Unbehauen, “Regelungstechnik Bd.1-3” (“Control Engineering Vol. 1-3”), Vieweg Verlag, Wiesbaden].

To implement the PMD system, an actuator supplying low-noise and reproducible propagation time delays is preferably used for phase delay, in this case: a phase shifter PS. Alternatively or in addition, the phase can also be measured by means of an accurate phase comparator PCOMP. The design and operating principle of the phase comparator are described for example in U. Rhode, “Microwave and Wireless Synthesizers”, chap. 4.4, p. 288 ff, 1997, Wiley Publishers, New York; M. Meade, “Lock-in amplifiers: principles and applications”, chap. 3 p. 31 ff. 1983 IEE Electrical Measurement Series 1, or Analog Devices, “Data Sheet AD9901”, rev. B.

The PMD system can also be operated with other periodic modulation signals U_{mod}, \overline{U}_{mod}, U_{PMDmod}, \overline{U}_{PMDmod}, U_{TXmod}, e.g. rectangular or triangular signals.

FIG. 5 shows three embodiments of the signal preprocessing device PSP for a PMD device PMD with integrating output in the sub-figures 5a to 5c. Here, a reset signal R is triggered at regular intervals (see FIG. 1).

In FIG. 5a, the saw-shaped difference signal U_{d} (see FIG. 1) running in from the left is filtered by a low-pass filter TP1 and additionally differentiated in time in a differentiator TDiff. The low-pass filter TP1 and the differentiator TDiff can be implemented as one circuit or separately. By means of a switch S1 controlled by the reset signal R, the control loop CTR is only closed if no reset signal R is applied. A subsequent second low-pass filter TP2 serves to suppress the switching spike.

With this method, only the control time tᵢ between two reset signals R is available for settling the control loop; during the control time t_{R}, the measurement is interrupted. The voltage value proportional to the distance is recorded expediently in the steady state directly prior to the opening of the switch S1.

FIG. 5b shows an arrangement in which the peak value attained before the triggering of the inverted reset signal \overline{R} is sampled by means of a sample-and-hold gate SHT and this is used as control variable U′_{d}. This avoids the interference resulting in the arrgangement shown in FIG. 5a during opening and closing of the control loop. The solution is relatively slow, however. A first low-pass filter TP1 serves here to adjust the signal bandwidth to the switching speed of the sample-and-hold gate SHT. S1 can also be switched with the non-inverted reset signal R.

FIG. 5c shows an arrangement in which no switch is used. In this case the signal U_{d} is smoothed by means of the first low-pass filter TP1, differentiated and rectified by means of the second low-pass filter TP2. The control variable U′_{d} obtained in this way is applied to the controlled system CTR. In this case, U′_{d}=0 is preferably chosen. This ideally yields a constant control variable U′_{d}, since U′_{d} is zero during the reset phase (see FIG. 1), and during the measuring phase the control variable U′_{d} is kept at zero by the control loop.

Operation with U′_{d}=maximum is also possible, but requires a more precise configuration of the low-pass filters TP1, TP2 on account of the fluctuations of U′_{d}. As already shown in the arrangement in FIG. 5a, TP1 serves to smooth the step changes in the saw signal. The limit frequency of the first low-pass filter TP1 is therefore configured to approximately 5.5 fₜᵢ similarly to the considerations made in the arrangement shown in FIG. 5a.

The second low-pass filter TP2 serves here to completely smooth the differentiated signal. In the determination of the limit frequency, a choice must be made between the fastest possible adjustment, which requires a higher limit frequency, and a good smoothing of the rectified signal, which requires a lower limit frequency. A possible compromise here lies in a limit frequency of the second low-pass filter TP2, corresponding to approximately 0.3·fti. For PMD output signals Uₐ, U_{b} with a frequency of approx. 1 kHz (see FIG. 1), this then results in limit frequencies of 7.5 kHz for the first low-pass filter TP1, and approx. 300 Hz for the second low-pass filter TP2.

Of course, other methods of signal preprocessing can also be applied.

FIG. 6 shows various (V,t) signal waveforms of a PMD system with control loop, namely from top to bottom: the output signal Uₐ of the

PMD device PMD, the reset signal R, the inverted reset signal \overline{R}, a switching waveform of the switch S1 from FIG. 5a and a switching waveform of the switch S1 from FIG. 5b.

The signal waveform marked by “a)” shows the corresponding timing for the switch S1 shown in FIG. 5a. The choice of the limit frequency of the low-pass filters TP1, TP2 is important in this arrangement. Firstly, the purpose of the first low-pass filter TP1 is to smooth the saw waveform of the difference voltage U_{d} to the extent that the steep rising edges do not cause any too abrupt changes to the following series-connected differentiator TDiff. Secondly, the falling part of the signal should be available in as linear a form as possible and hence as a constant value after differentiation as control variable U′_{d}. It is preferred to use the fundamental wave and the first two harmonic waves of the signal, i.e. to choose a limit frequency of approx. 5.5·fti for the first low-pass filter TP1. The second low-pass filter TP2 then serves simply to filter out additional interference caused by the differentiator. Its limit frequency is therefore chosen to be identical to that of the first low-pass filter. For output signals with a frequency of approx. 1 kHz (see FIG. 1), this results in a limit frequency of approx. 7.5 kHz both for the first low-pass filter TP1 and for the second low-pass filter TP2.

The signal waveform marked by “b)” shows the corresponding timing for the switch S1 in FIG. 5b. In this case, the choice of the limit frequency of the low-pass filter TP1 results directly from the sampling time of the sampling gate, preferably the sample-and-hold gate SHT. According to the Nyquist criterion (sampling theorem), the frequency of the sampled signal must be limited to half the sampling frequency [J, Proakis, D. Manolakis, “Digital Signal Processing”, chap. 6, p. 395 ff., Second Edition, Macmillan Publishing]. Thus, for a sample gate, e.g. using a sampling time tₛ of 10 μs, this results in a limit frequency of the low-pass filter of f_{g}=1/(2·tₛ)=50 kHz.

FIG. 7 shows a circuit schematic of a PMD system in which the phase shifter PS is built as a comparator CMP with a D flip-flop DF as a clock splitter.

In this arrangement, the comparator CMF is driven by means of a monotonous clock signal TS continuously alternating between minimum and maximum values, e.g. sinusoidal or triangular. A turn-on and turn-off time is specified by means of a threshold voltage Uₛ. When the threshold voltage Uₛ is reached, the comparator output switches its output voltage U_{mod} to “logic one”; if the threshold voltage Uₛ is undershot, the output switches back to “logic zero”. In addition to the variation in switching time, this leads to the variation of the corresponding pulse widths, which is why a clock splitter according to [U. Tietze, T. Schenk, “Halbleiter-Schaltungstechnik” (“Semiconductor Switching Technology), chapter 10, p. 232 ff, tenth edition, Springer Verlag Berlin] is connected at the output, thus restoring the clock ratio 1:1.

The advantage of this implementation of the phase shifter PS consists in the ease with which it can be produced using standard components (e.g. CMOS logic), and in the ease with which it can be integrated into future PMD CMOS chips. The disadvantage lies in the setting range for the phase delay φ_{d} which is limited to 90°.

In order to avoid this restriction and also to avoid non-linearities occurring at the edge of the control range, the arrangement can be extended by means of additional connectable phase shifters PS with defined delays. A further implementation possibility is to use filters with corresponding group propagation times as switchable time delay elements.

A control loop for setting the modulation frequency f_{mod} can also be used instead of the control loop for setting the phase delay φ_{d}.

FIG. 8 shows the switching waveforms of the PMD system in FIG. 7 in the form of a (V,t) plot for a sinusoidal mean-free clock signal TS, the output voltage U_{mod} of the D flip-flop DF and the modulation voltage U_{TXmod}, by means of which the amplitude of the transmitter E is controlled.

Particularly advantageous is an arrangement in which an array consisting of individual PMD elements PMD is used, and in each of the PMD elements PMD a phase shifter PS according to this exemplary embodiment is integrated with corresponding controlled system. This provides a signal, typically a voltage value, in each PMD device PMD, said signal being directly dependent on the propagation time τ_{tof} or on the distance from the object.

FIG. 9 shows a circuit schematic of a PMD system with variable modulation frequency f_{mod} and controlled system CTR.

As already was the case previously with the phase control loop, direct generation of a distance-proportional voltage is also possible here in the phase control loop. The arrangement consists of a VCO regulator VCO as a detunable oscillator OSC, on which the output voltage U_{1fc} of the controlled system CTR acts as an actuating signal. The output signal of the VCO regulator VCO is converted as previously in the PMD driver T into the necessary modulation signals U_{mod}, \overline{U}_{mod} for the PMD element PMD and from there reaches the PMD element PMD. The transmitter E is, in turn, modulated in intensity by the output signal of the VCO regulator VCO. The modulated wave reaches the PMD element PMD either directly or by reflection and, once there, as described previously, generates a difference signal U_{d} proportional to the phase shift Δφ. Ideally, no additional delays occur due to propagation times or modulations, and then the following applies: Δφ=φ_{tof}. The difference signal in turn is applied to the controlled system CTR, if necessary preprocessed as control variable U′_{d}. The controlled system CTR then sets the modulation frequency f_{mod} for which the control variable is

a) U′_{d}=zero,

b) U′_{d}=maximum, or

C) U′_{d}=minimum

In case a), the value is set to the modulation frequency f_{mod} whose half period T/2 is an integral divisor of the propagation time difference τ_{tof}.

In case b), on the other hand, the value is set to the modulation frequency f_{mod} whose quarter period or quarter period plus an integral multiple of the basic period is a divisor of the propagation time difference: τ_{tof}=n·T+T/4.

In case c), a propagation time difference τ_{tof}=n·T+3·T/4 is set analogously. To avoid ambiguities, the lowest possible frequency is preferably selected as the starting point at the beginning of the control operation. Starting from this, the frequency is then adjusted in the direction of the first next-higher frequency, which then sets the desired value of U′_{d}. Thus, the following then applies to the propagation time difference τ_{tof}.

a) τ_{tof}=T/2,

b) τ_{tof}=T/4,

c) τ_{tof}=3T/4.

The frequency can be determined via the measurement of the voltage U_{1fc} set on the VCO regulator VCO, or preferably via an additional f-to-U converter (FUC). Analogously to the corresponding methods for phase control, the choice of the target variables according to b) or c) offers a direct separation between background light and modulated light.

The selectable minimum and maximum frequencies fₘᵢₙ and fₘₐₓ define the unequivocal measuring range. The following applies to the minimum distance dₘᵢₙ from the sensor and the maximum distance dₘₐₓ:

$$\begin{matrix}a ) {d}_{min} = \frac{c}{4 \cdot f max} , {d}_{max} = \frac{c}{4 \cdot f min} \\ b ) {d}_{min} = \frac{c}{8 \cdot f max} , {d}_{max} = \frac{c}{8 \cdot f min} \\ c ) {d}_{min} = \frac{3 \cdot c}{8 \cdot f max} , {d}_{max} = \frac{3 \cdot c}{8 \cdot f min}\end{matrix}$$

For PMD elements PMD with fₘᵢₙ=10 MHz and fₘₐₓ=160 MHz, this produces measuring ranges of:

a) 0.5 m-7.5 m,

b) 0.25 m-3.75 m,

c) 0.75 m-11.25 m

The control variable U′_{d} can be recorded similarly to the methods proposed for the phase control loop, since ideally the integration time of typical output signals (see FIG. 1) within the proposed bandwidth is independent of the modulation methods used.

f/U converters with analog output voltage can be used for an f-to-U conversion. A description of f/U converters is contained e.g. in (E. Schrüfer, “Elektrische Messtechnik” (“Electrical Measurement Techniques”), chapter 6.4.2, p. 385 ff, 4. edition, Carl Hanser Verlag Munich, or D. Nährmann, “Praxis der Messtechnik” (“Measurement Engineering Practice”), chapter 8, Franzis Verlag]. Preferably, the frequency is determined by means of a counter, e.g. as described in [D. Nährmann, “Praxis der Messtechnik”, chapter 8.2, Franzis Verlag], which is incremented by one with each pulse. By reading out the counter status at fixed time intervals, a digital word is then directly available for the modulation frequency f_{mod} and hence the propagation time difference τ_{tof}. A subsequent A/D conversion for further processing in the microprocessor MP is then no longer necessary.

In this figure, the frequency is preferably generated by means of the VCO regulator VCO. However, other detunable frequency sources such as digital frequency synthesizers, for example PLL synthesizers or direct digital synthesizers (DDS), can also be used instead of a VCO regulator VCO.

With the exemplary embodiments of PMD systems with control loop shown here, the phase shifter PS is usually connected in series in the circuit ahead of the transmitter E. However, the phase shifter PS, and generally a phase delay element, can equally be inserted in the circuit ahead of the PMD element PMD. It is then only necessary to reverse the phase relationships for a negative delay.

The PMD systems with control loop are not limited to lightwaves. Rather, the method can be used generally for elements with a PMD-typical arrangement for receiving electromagnetic waves, e.g. microwaves. Accordingly, transmitters E may, for example, be present in the form of lasers, diodes and diode arrays, fluorescent lamps, but also microwave transmitters and radar transmitters.

1. PMD system, comprising
at least one PMD element (PMD),
at least one intensity-modulatable transmitter (E),
at least one controlling electronics device (FG) by means of which
the PMD element (PMD) and the transmitter (E) can each be controlled using at least one modulation voltage (U_{mod}, \overline{U}_{mod}, U_{TXmod}) of the same modulation frequency (f_{mod}) and
by means of which a phase shift (Δφ) can be modified via an actuating signal,
characterized in that
a controlled system (CTR) is provided into which at least one output signal (Uₐ, U_{b}, U_{d}) of the PMD element (PMD) can be fed as a control variable (U′_{d}), and whose output signal (U₁ₚₕₛ, U_{1fc}) can be fed as an actuating signal into the controlling electronics device (FG), where
the control variable (U′_{d}) can be set to the value of a predefined target variable by the controlled system (CTR).

2. PMD system according to claim 1, wherein
a signal preprocessing device (PSP) is inserted in the circuit ahead of the controlled system (CTR).

3. PMD system according to claim 2, wherein
the signal preprocessing device (PSP) comprises a first low-pass filter (TP1), followed by a device for time differentiation (TDiff), followed by a switch (S1) that is controllable by means of a reset
signal (R, \overline{R}), and followed by a second low-pass filter (TP2).

4. PMD system according to claim 2, wherein
the signal preprocessing device (PSP) comprises a first low-pass filter (TP1), followed by a switch (S1) that is controllable by means of a reset signal (R), and followed by a sample-and-hold gate (SHT).

5. PMD system according to claim 2, wherein
the signal preprocessing device (PSP) comprises a first low-pass filter (TP1), followed by a device for time differentiation (TDiff), and followed by a second low-pass filter (TP2).

6. PMD system according to one of the claims 3 or 5, wherein
a limit frequency of the first low-pass filter (TP1) lies in the range of 5.5 times the integration time (fₜᵢ).

7. PMD system according to claim 6, wherein
a limit frequency of the second low-pass filter (TP2) lies in the range of three times the integration time (fₜᵢ).

8. PMD system according to one of the claims 1 to 7, wherein
the at least one modulation voltage (U_{mod}, \overline{U}_{mod}) controlling the PMD element (PMD) and the at least one modulation voltage (U_{TXmod}) controlling the transmitter (E) are provided with a phase delay (φd) with respect to each other by means of the controlling electronics device (FG).

9. PMD system according to claim 8, wherein
a phase comparator (PCOMP) is provided, at whose one input a modulation voltage (U_{mod}, \overline{U}_{mod}) controlling the PMD element (PMD) can be applied and at whose further input a modulation voltage (U_{TXmod}) controlling the transmitter (E) can be applied, from which a phase difference of the incoming modulation voltages (U_{mod}, \overline{U}_{mod}, U_{TXmod}) can be determined.

10. PMD system according to one of the claims 8 or 9, wherein
the controlling electronics device (FG) at least includes
a controllable driver (T) which supplies the PMD element (PMD) with the at least one modulation voltage (U_{mod}, \overline{U}_{mod}) generated from a clock signal (TS),
a phase delay element (PS) controllable by the controlled system (CTR), by means of which the clock signal (TS) can be forwarded as a modulation voltage (U_{TXmod}) to the transmitter (E) with a phase delay (φd).

11. PMD system according to claim 10, wherein
the phase delay element is provided in the form of a phase shifter (PS) which contains a comparator (CMP) with a D flip-flop connected in series at its output as a clock splitter.

12. PMD system according to claim 11, wherein
at least one phase shifter (PS) together with in each case at least one controlled system (CTR) is integrated into the PMD element (PMD).

13. PMD system according to claim 12, which comprises multiple PMD elements (PMD).

14. PMD system according to one of the claims 1 to 7, wherein
the modulation frequency (f_{mod}) can be set by means of the controlling electronic device (FG).

15. PMD system according to claim 14, wherein
the controlling electronics device (FG) at least includes
a controllable driver (T) which supplies the PMD element (PMD) with the at least one modulation voltage (U_{mod}, \overline{U}_{mod}) generated from a clock signal (TS),
a detunable frequency source (OSC), by means of which the clock signal (TS) can be generated for the driver (T) and the modulation voltage (U_{TXmod}) can be generated for the transmitter (E).

16. PMD system according to claim 15, wherein
the clock signal (TS) of the detunable frequency source (OSC) can be fed into an f-to-U converter (FUC), particularly an incrementally counting f-to-U converter (FUC).

17. PMD system according to one of the claims 1 to 16, wherein
the values zero, minimum or maximum can be set as control variable (U′_{d}).

18. Method for controlling a PMD system according to one of the claims 14 to 16, wherein the lowest frequency is selected as the starting point at the beginning of a control operation and is then adjusted in the direction of the next-higher frequency, which sets the desired value of the control variable (U′_{d}).

19. Method for controlling a PMD system which comprises at least:
one PMD element (PMD),
one transmitter (E) for intensity-modulated transmission of electromagnetic waves,
at least one controlling electronics device (FG), by means of which
the PMD element (PMD) and the transmitter (E) can in each case be controlled using at least one modulation voltage (U_{mod}, \overline{U}_{mod}, U_{TXmod}) of the same modulation frequency (f_{mod}), and
by means of which a phase shift (Δφ) can be modified via an actuating signal,
characterized in that
the actuating signal is applied to the controlling electronics device (FG) by means of a controlled system (CTR) such that a control variable (U′_{d}) characterizing the PMD system is set automatically to a value of a predefined target variable, with at least one output signal (Uₐ, U_{b}, U_{d}) of the PMD element (PMD) being used to determine the control variable (U′_{d}).

20. Method according to claim 19, wherein
the phase shift (Δφ) is modified by a detuning of the phase delay (φd) and/or the modulation frequency (f_{mod}).
